(19) United States
(12) Patent Application Publication
(10) Pub. No.: US 2005/0078487 A1
(43) Pub. Date: Apr. 14, 2005

(54) Plate

(76) Inventors: Martin Tietze, Eisenach (DE); Peer Quendt, Eisenach (DE); Frank Gotthardt, Eisenach (DE)

Correspondence Address: SUGHRUE MION, PLLC, 2100 PENNSYLVANIA AVENUE, N.W., SUITE 800, WASHINGTON, DC, 20037, US

(21) Appl. No.: 10/502,736

(22) PCT Filed: Jan. 23, 2003
(86) PCT No.: PCT/EP03/00680

(30) Foreign Application Priority Data
Dec. 2, 2002 (DE) 20218626.1

(51) Int. Cl. B60Q 1/56

(52) U.S. Cl. 362/497

(57) ABSTRACT

A plate (1), in particular a motor vehicle licence plate, comprises a casing (3) including a rear wall (4) and an edge portion (5) which surrounds that rear wall (4) and which projects forwardly and which extends around a light transmission opening (7) through which a flat symbol carrier extending in parallel relationship with the rear wall (4) of the casing is visible, wherein provided for illumination between the rear wall (4) and the symbol carrier is an electrically activatable light film (14) which transilluminates at least the regions of high transparency of the symbol carrier from the rear. To achieve reflection properties arranged in front of the light film and in parallel relationship therewith is a reflection film (15) which is at least region-wise transparent for the light coming from the rear from the light film and which reflects extraneous light which impinges thereon from the outside through the light transmission opening. To avoid Newton's rings and the like provided between the inside of an at least region-wise transparent light cover (9) which closes the light transmission opening and the surface theretowards of the reflection film (15) is an areal adhesive connection.

The invention concerns a plate, in particular a motor vehicle licence plate, of the kind set forth in the classifying portion of claim 1.

A motor vehicle licence plate which is in accordance with the classifying portion of claim 1 is known from German utility model No 297 12 954.6. In that known arrangement the symbol carrier is a stiff plastic plate member arranged in a casing in the form of a holding frame in front of an electrically activatable light film formed by an electroluminescence film. The light transmission opening which is surrounded by the holding frame and through which the light delivered by the light film in the switched-on condition issues to the exterior after it has shone through the symbol carrier from the rear is not further closed as, because of its stiffness, the symbol carrier can be readily securely held by the holding frame and thereby also fixes the electrically activatable light film which is disposed behind it.

That known arrangement is advantageous insofar as the integrated, electrically activatable light film provides for direct backlighting of the identification without any need for a separately arranged lighting system. This means that the known licence plate is of an extremely compact and space-saving nature.

There is the disadvantage that there are no stiff plastic plate members, that is to say which are suitable as a closure for the light transmission opening, which are both transparent for the light delivered by the electrically activatable light film and coming from the rear and also reflecting for extraneous light which comes from the exterior and which is incident on the symbol carrier, as is required by legislation in particular for motor vehicle licence plates, but is also advantageous or required for other plates, for example traffic signs.

Accordingly the object of the invention is to develop a plate of the kind set forth in the opening part of this specification in such a way that, in addition to the inherent lighting arrangement which is implemented by means of an electrically activatable light film, it also has reflecting properties.

To attain that object, the invention provides the features recited in claim 1.

The basic starting point for attaining that object in that fashion is the fact that available on the market are plastic films which are substantially transparent for light impinging thereon from the rear while they reflect light incident on the front side thereof. They include in particular retroreflective films which are smooth on their front side and which have microprismatic structures which project from their rear side and at the interfaces of which light incident from the front is reflected by total reflection. However it is also possible to obtain films in which the reflecting structures are completely embedded. In the present context, independently of the specific structure and the actual physical mode of operation, the only point of significance is that the film used, which is referred to hereinafter briefly as the ‘reflection film’, has a high level of transparency for light coming from the rear and greatly reflects light which is incident from the front.

As however such reflection films do not have any inherent stiffness, they cannot serve as a ‘closure panel’ for the light exit opening of the plate casing, in the manner as is known from above-discussed German utility model No 297 12 954.6.

Therefore, in order to stabilise the electrically activatable light film and the reflection film arranged in front thereof in the casing, it is necessary for the light transmission opening to be closed by a light cover which is transparent in both directions and which primarily performs a mechanical holding function.

Without further features, in this respect however there would then be the problem that the reflection film would bear in irregularly close relationship against the inside the light cover over the entire surface area and would even be in part sucked thereagainst so that, even with uniform illumination from the inside or the outside, there would still be zones of differing lightness and darkness, or the formation of Newton's rings. That is not only unattractive but it is also inadmissible in particular in relation to motor vehicle licence plates. In accordance with the invention, to overcome those difficulties, provided between the inside or rear side of the light cover and the front surface which is theretowards of the reflection film is an areal adhesive connection.

That areal adhesive connection can be embodied in differing ways.

In a particularly preferred embodiment the front side of the reflection film is glued over an area directly to the rear side of the light cover. In that case, the adhesive can be firstly applied, in particular by a transfer process, to the front side of the reflection film and the latter can then be pressed against the rear side of the light cover. Alternatively the adhesive is firstly applied to the rear side of the light cover and the reflection film is then pressed against that adhesive layer. In that case the reflection film can either itself have no adhesive or it may also carry an adhesive layer which supplements that on the light cover. In the last-mentioned case the two mutually supplementing layers can comprise materials which each, considered on their own, have no or only slight adhesive properties and only jointly develop a strong adhesive action when they are brought into contact with each other and/or are involved in a chemical reaction.

It is essential that the connection is effected uniformly over the entire surface which is visible from the front so that there are no visible differences in brightness in terms of later active transillumination (which is effected by the light film) and passive transillumination (which is effected by the light incident from the front and thereafter reflected).

In accordance with another advantageous variant the adhesive connection between the reflection film and the light cover is afforded by a further film which is coated with adhesive and which has very high transparency in both directions and which produces such a close and intimate connection of the reflection film to the light cover that the above-mentioned optical disturbances are avoided.

A particular advantage of the plate according to the invention is that a separate symbol carrier is no longer absolutely necessary. Rather, the symbols which are to be represented on the plate can be provided on any of the surfaces which, as viewed by a person viewing the plate, are in front of the rear surface of the reflection film, that is to say on the front side of the reflection film, the rear or front side of the film which is coated with adhesive on both sides (if such a film is present) or the rear or front side of the light cover. In that case there is no need for all symbols which are to be represented to be disposed on the same surface.

It is particularly preferred for the symbols to be disposed on one or more of the film surfaces as they can be very easily printed.

It is also advantageous if the electrically activatable film is loosely inserted and held between the rear wall of the casing and the film or films disposed in front thereof and fixedly connected to the light cover, so that there is no need for any additional fixing means.

The electrically activatable light film may involve an electroluminescence film which is actuated in known manner with an ac voltage which in the case of a motor vehicle licence plate can be produced by means of a power supply device from the on-board dc voltage system.

It is particularly preferred however for the electrically activatable light film used to be in the form of a film with organic light emitting diodes, a so-called OLED film, which affords the advantage that it can be operated with a dc voltage which can be derived from an on-board dc voltage by an extremely simple ancillary circuit. The operating electronics required for electroluminescence films are omitted, as well as particular insulating measures. A further advantage of OLED films is the substantially higher luminous density which can be achieved.

The above-mentioned and further advantages and properties of a plate according to the invention are set forth in the appendant claims.

The invention is described hereinafter by means of an embodiment with reference to the drawing in which:

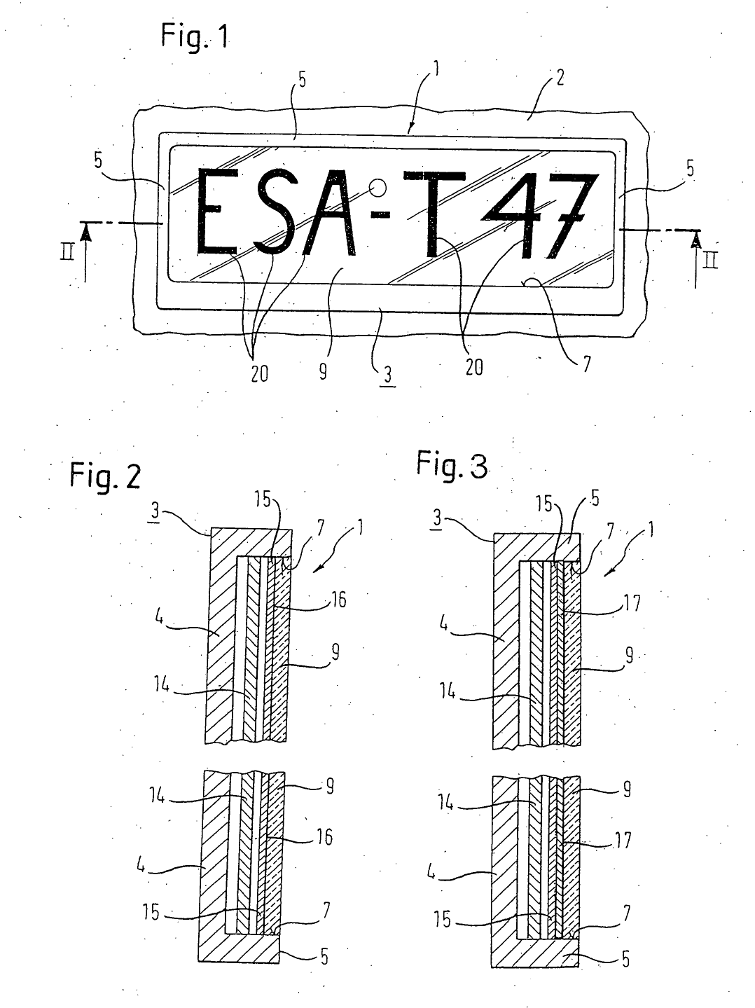

FIG. 1 is a front view of a plate according to the invention in the form of a motor vehicle licence plate,

FIG. 2 is a highly diagrammatic view in section through a first embodiment of the plate in FIG. 1 along line II-II, in which the reflection film is glued directly to the light cover, and

FIG. 3 is a view corresponding to FIG. 2 of a second embodiment of a plate according to the invention, in which the reflection film is glued to the light cover by means of a film coated with adhesive on both sides.

In the embodiments illustrated in the Figures the plate 1 according to the invention which is in the form of a licence plate of a motor vehicle is fixed by known means (not shown) to the bodywork panel 2 of a motor vehicle.

As can be seen in particular from FIGS. 2 and 3 the plate 1 has a casing 3 with a rear wall 4 carrying an edge portion 5 which extends around the entire periphery of the rear wall and which extends forwardly, that is to say towards the person viewing it (towards the right in FIGS. 2 and 3) and which can be integrally connected to the rear wall 4.

The forwardly projecting edge portion 5 encloses a light transmission opening 7 closed by a transparent light cover 9. The light cover 9 can be fixed to the peripherally extending edge portion 5 of the casing 3 in any suitable manner.

Disposed in front of the rear wall 4 of the casing 3 is an electrically activatable light film 14 which is of approximately the same area as the rear wall 4 and which bears with its flat sides against the rear wall 4 and against the reflection film 15 connected by adhesive to the light cover 9. The spacings shown in FIGS. 2 and 3 between the light film 14 and the rear wall 4 and the reflection film 15 respectively serve only for illustration purposes and in reality are vanishingly small.

The electrically activatable light film 14 shown entirely at the left in FIGS. 2 and 3 is connected in a manner not shown to an electrical power source in such a way that electrical voltage can be applied thereto by means of a switch. It is formed either by an electroluminescence film or by an OLED film. In the activated condition the entire film 14 uniformly lights up and the light emanating therefrom passes through the layers arranged to the right thereof in FIGS. 2 and 3 and in particular the light cover 9 so that, viewing in the direction of FIG. 1, the entire light transmission opening 7 appears to be brightly lit from the rear.

The reflection film 15 is arranged to the right beside the electrically activatable light film 14 in such a way that it reflects extraneous light which is incident thereon from the right, that is to say from the outside through the light cover 9, in such a way that it reverses its path and issues through the light cover 9 in approximately the same direction as that in which it entered. In addition the reflection film 15 is at least partially transparent for light which arrives from the rear, that is to say from the left in FIGS. 2 and 3, so that a considerable part of the light emitted by the electrically activatable light film 14 in the direction of the light transmission opening 7 can pass therethrough.

In the embodiment shown in FIG. 2 the reflection film 15 is connected to the rear side of the light cover 9 directly by an areal adhesive means 16. For the production thereof it is particularly preferred that a transfer process be employed, in which a layer of a transfer adhesive is firstly applied to a carrier paper and then is laminated on to the smooth, that is to say non-microprismatic front side of the reflection film 15. Then the layer composite consisting of the reflection film, the adhesive and the carrier paper is cut to the required size, the carrier paper is pulled off and the reflection film 15 is uniformly pressed with the adhesive layer which has remained thereon leading, from the rear, against the rear side of the light cover 9, for example by means of a rubber roller, so that the air between the layers is displaced. That affords an adhesive connection which is uniform over the area involved and with which no zones of differing lightness or darkness or the formation of Newton's rings occur.

That procedure is particularly advantageous if the light cover 9, unlike the structure shown in FIGS. 2 and 3, is integrally connected to the edge portion 5 forming a frame and same is releasably secured to the rear wall 4 of the casing 3.

In the embodiment shown in FIG. 3 disposed between the reflection film 15 and the inside of the light cover 9 is a further film 17 carrying an adhesive coating on its two flat sides. The film 17 is transparent to a very high degree so that both the light coming from the inside from the electrically activatable light film 14 and also the extraneous light coming from the outside, both prior to and also after its reflection at the reflection film 15, can pass through same without substantial loss in intensity.

The film 16 which is coated with adhesive on both sides can firstly be laminated by its one adhesive side to the reflection film, its other flat side being covered by a protective paper. After the operation of cutting to size which has already been mentioned above the protective paper is then pulled off and the composite consisting of the reflection film 15 and the adhesive film 17 is glued to the rear side of the light cover 9 in the above-described manner, whereby once again the above-discussed advantages are achieved.

Particularly the occurrence of defined dark spots and/or Newton's rings is avoided, which without glueing would be clearly visible when viewing the plate from the outside and would detrimentally influence the appearance of the plate or would hinder the utility thereof.

The symbols 20 which are visible to a person viewing the plate and which are shown in FIG. 1 and which are illustrated on the plate can be disposed on the front side and/or the rear side of a symbol carrier and differ in terms of their transparency from the other surface regions of the symbol carrier. In the present case they are of a practically opaque nature so that in comparison with the other virtually completely transparent regions of the symbol carrier they appear black.

The above-mentioned symbol carrier does not necessarily involve an additional component part. Rather, the symbols to be represented can be printed on the front side of the reflection film 15 and/or optionally on the front side or the rear side of the adhesive film 17. Likewise it is possible for the symbols 20 to be provided on the inside surface and/or the outside surface of the light cover 9. There they can also be in the form of raised structures, that is to say structures which project beyond the flat side in question.

As a deviation therefrom it will be noted that it is also possible for an additional symbol carrier which is not shown in FIGS. 2 and 3 and which is in the form of a flat plate member or film to be arranged in front of the reflection film 15.

Depending on the respective purpose of use of the plate according to the invention the symbol carrier may also have more than two transparency graduations. In addition one or more of the films or the outside or inside surface of the light cover may be coloured differently in different regions so that this here affords further design options which for example also permit a plate according to the invention to be used as a traffic sign.

1. A plate (1), in particular a motor vehicle licence plate, comprising a casing (3) including a rear wall (4) and an edge portion (5) which surrounds that rear wall (4) and which projects forwardly and which extends around a light transmission opening (7) through which a flat symbol carrier extending in parallel relationship with the rear wall (4) of the casing is visible, which symbol carrier has regions of differing transparency for representation of the symbols (20) thereon, wherein provided for illumination between the rear wall (4) and the symbol carrier is an electrically activatable light film (14) which transilluminates at least the regions of high transparency of the symbol carrier from the rear, characterised in that arranged in front of the electrically activatable light film (14) and in parallel relationship therewith is a reflection film (15) which extends at least over considerable portions of the area of the light exit opening (7), which is at least region-wise transparent for the light coming from the rear from the electrically activatable light film (14) and which reflects extraneous light which passes from the exterior through the light exit opening (7) and impinges on the reflection film,
that there is provided an at least region-wise transparent light cover (9) closing the light exit opening (7), and
that an areal adhesive connection is provided between the inside of the light cover (9) and the surface theretowards of the reflection film (15).

2. A plate according to claim 1 characterised in that the areal adhesive connection includes a direct areal adhesive join (16) of the front side of the reflection film (15) to the inside of the light cover (9).

3. A plate according to claim 1 characterised in that the areal adhesive connection includes an at least region-wise transparent film (17) which is arranged between the reflection film (15) and the light cover (9) and which is coated on both sides with adhesive and which is glued in areal relationship on the one hand to the reflection film (15) and on the other hand to the inside of the light cover (9).

4. A plate according to claim 1, characterised in that the light cover serves as a symbol carrier.

5. A plate according to claim 3, characterised in that the film (16) coated with adhesive serves as the symbol carrier.

6. A plate according to claim 1, characterised in that the reflection film (15) serves as the symbol carrier.

7. A plate according to claim 1, characterised in that there is provided an independent symbol carrier.

8. A plate according to claim 7 characterised in that the symbol carrier is in the form of an inherently stiff plate member.

9. A plate according to claim 7 characterised in that the symbol carrier is a flexible film.

10. A plate according to claim 1, characterised in that the electrically activatable film (14) is inserted between the rear wall (4) of the casing (3) and the reflection film (15) in a condition of bearing loosely thereagainst.

11. A plate according to claim 1, characterised in that the electrically activatable film (14) is glued directly to the rear side of the reflection film (15).

12. A plate according to claim 1, characterised in that the electrically activatable film (14) is glued to the rear side of the reflection film (15) with the interposition of further transparent layers.

13. A plate according to claim 1, characterised in that the electrically activatable film (14) is glued to the rear wall (4) of the casing (3).

14. A plate according to claim 1, characterised in that the electrically activatable light film (14) is an electroluminescence film.

15. A plate according to claim 1, characterised in that the electrically activatable light film (14) is a light film with organic light emitting diodes (OLED film).
